(19) United States
(12) Patent Application Publication
(10) Pub. No.: US 2026/0172962 A1
(43) Pub. Date: Jun. 18, 2026

(54) Variable Window Size Determination

(71) Applicant: PassiveLogic, Inc., Holladay, UT (US)

(72) Inventor: Marciano Carter Preciado, Salt Lake City, UT (US)

(73) Assignee: PassiveLogic, Inc., Holladay, UT (US)

(21) Appl. No.: 18/980,873

(22) Filed: Dec. 13, 2024

(51) Int. Cl. H04W 52/02

(52) U.S. Cl. CPC H04W 52/0216; H04W 52/0229

(57) ABSTRACT

Various embodiment relate to a method, apparatus, and non-transitory media, including one or more of the following: determining a target time at which a communication via the communications interface is anticipated to occur; determining a padding based on an accuracy of a clock of the network device, an accuracy of a clock of a different device with which the communication will occur, and the target time; determining a wake time based on the padding; sleeping until the wake time; and after waking at the wake time, performing the communication.

### FIELD OF INVENTION

The present disclosure relates to wireless sensor operation; more specifically, ways to determine a window length required to receive a message.

### SUMMARY

This summary is provided to introduce a selection of concepts in a simplified form that are further described below in the Detailed Description section. This summary does not identify required or essential features of the claimed subject matter.

In various embodiments described herein, a network device is disclosed, which includes: a memory; a communications interface; and a processor in communication with the memory configured to determine a target time at which a communication via the communications interface is anticipated to occur; determine a padding based on an accuracy of a clock of the network device, an accuracy of a clock of a different device with which the communication will occur, and the target time; determine a wake time based on the padding; sleeping until the wake time; and after waking at the wake time, perform the communication.

In various embodiments described herein, in determining the wake time, the processor is configured to subtract the padding from the target time.

In various embodiments described herein, the processor is further configured to determine a next sleep time based on the padding; and after waking at the wake time, place the network device in the sleep state at the next sleep time.

In various embodiments described herein, in determining the next sleep time, the processor is configured to subtract the padding from the target time.

In various embodiments described herein, in determining the padding, the processor is configured to identify a time interval between a current time and the target time, and estimate a worst case clock drift using accuracy of the clock of the network device and an accuracy of the clock of the different device over the time interval.

In various embodiments described herein, in estimating the worst case clock drift, the processor is configured to determine accuracy of the clock of the network device based on a property of a crystal oscillator of the clock of the network device, and determine accuracy of the clock of the different device based on a property of a crystal oscillator of the clock of the different device.

In various embodiments described herein, estimating the worst case clock drift further includes estimating the amount of clock drift between a the current time and the target time using the accuracy of the clock of the network device giving a device drift time.

In various embodiments described herein, estimating the worst case clock drift further includes estimating the amount of clock drift between the current time and the target time using the accuracy of the clock of the different network device giving a different drift time.

In various embodiments described herein, the padding value is the device drift time plus the different drift time.

In various embodiments described herein, the padding size is twice the padding value plus the message length.

In various embodiments described herein, the communication is a synchronization communication.

In various embodiments described herein, a method is disclosed, which includes: determining a target time at which a communication via the communications interface is anticipated to occur; determining a padding based on an accuracy of a clock of the network device, an accuracy of a clock of a different device with which the communication will occur, and the target time; determining a wake time based on the padding; sleeping until the wake time; and after waking at the wake time, performing the communication.

In various embodiments described herein, the padding is used to determine a synchronization interval.

In various embodiments described herein, at a synchronization interval, a universal synchronization time is sent from a central device to at least one device in direct communication with the central device.

In various embodiments described herein, the universal synchronization time is sent in a sync message.

In various embodiments described herein, the universal synchronization time is sent to a next device during a regularly scheduled message time.

In various embodiments described herein, a non-transitory machine-readable medium encoded with instructions for execution by a processor for causing a device to trigger an action on a second device is disclosed, the non-transitory machine-readable medium including: instructions for determining a target time at which a communication via the communications interface is anticipated to occur; instructions for determining a padding based on an accuracy of a clock of the network device, an accuracy of a clock of a different device with which the communication will occur, and the target time; instructions for determining a wake time based on the padding; instructions for sleeping until the wake time; and instructions for after waking at the wake time, performing the communication.

These, and other, aspects of the invention will be better appreciated and understood when considered in conjunction with the following description and the accompanying drawings. The following description, while indicating various embodiments of the embodiments and numerous specific details thereof, is given by way of illustration and not of limitation. Many substitutions, modifications, additions or rearrangements may be made within the scope of the embodiments, and the embodiments includes all such substitutions, modifications, additions or rearrangements.

### BRIEF DESCRIPTION OF THE FIGURES

Non-limiting and non-exhaustive embodiments of the present embodiments are described with reference to the following FIGURES, wherein like reference numerals refer to like parts throughout the various views unless otherwise specified.

FIG. 1 illustrates an example generalized hardware diagram for implementing variable window size determination;

FIG. 2 illustrates an example device diagram for implementing variable window size determination;

FIGS. 3 and 4 depict views of a network device diagram illustrating the potential transmission of a message;

FIG. 5 illustrates an example method for enabling a device to create and use a variable window;

FIG. 6A is an example illustration of how to determine a padding time based on clock drift;

FIG. 6B is an example illustration of how to determine a window length based on padding time and message length;

FIG. 7 is an example illustration of how to determine a wake up time based on padding time and message length for a given message;

FIG. 8 is an example illustration of a way to determine a universal sync time based on window padding length;

FIG. 8 is an example illustration of a way to determine a universal sync time based on window padding length;

FIG. 9A is an example illustration of a universal synchronization message at a first hop from a central communication device;

FIG. 9B is an example illustration of a universal synchronization message at a second hop from a central communication device;

FIG. 10 is an example timeline that describes ways for a device to reset an internal synchronization time when a device time is ahead of a universal time.

FIG. 11 is an example timeline that describes ways for a device to reset an internal synchronization time when a device time is behind a universal time.

FIG. 12 is an example method for a device to update its universal synchronization time.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as use herein, refers to a non-exclusive “or” (i.e., or), unless otherwise indicated (e.g., “or else” or “or in the alternative”). Additionally, the various embodiments described herein are not necessarily mutually exclusive and may be combined to produce additional embodiments that incorporate the principles described herein.

Wireless sensors are widely used and widely useful. These wireless sensor networks often rely on clocks to keep their networks synchronized. However, the different clock times tend to drift apart. Specifically, crystal clocks in sensors have slight differences in their clock oscillators, measured in parts per million (ppm) or parts per billion (ppb), which indicates how much a crystal's frequency may deviate from an ideal crystal oscillation. These differences in oscillation in different sensors have the effect of the clocks running at slightly different rates, affecting the accuracy of timing-dependent operations. This increases the chances of data transmission errors, packet loss, packet collisions, etc., which results in degraded performance and reduced reliability of the network. To keep sensors appropriately synchronized within a network, packets must be sent out that contain information to resynchronize a sensor within the network. If a synchronization packet is sent out too often to sensors, then too much energy and time is used for synchronization, interfering with network speed and efficiency. If a synchronization packet is sent out too infrequently, then the network can become unstable, such that connections are unstable, frequently lost, or cannot be made at all. Shorter synchronization intervals that reduce the time between synchronization events may increase latency due to more frequent radio transmissions, which can impact the overall responsiveness of the system. While there are many synchronization timing protocols, there still exist forms for synchronization timing that will benefit from a more exact time to send synchronization messages, thereby saving energy, decreasing latency in the system, and so forth.

Similarly, when communications in a network are sent from one upstream device to another downstream device, due to uncertainties in the exact time that a message will arrive, such as inaccuracies between different clocks in the network, the downstream device should have a window—a period of time the downstream device is actively waiting for a communication. When this window is too small, communications may be missed; when the window is too large, the downstream device may waste energy.

Accordingly, various methods are described herein for creating window length that takes into account specific aspects about clock characteristics of both upstream and downstream devices, to ensure that the window length for a particular communication may be as short as possible. According to some embodiments, a target time is determined when a communication from a different device via the communications interface is anticipated to occur. In some such embodiments, padding that creates a window of opportunity for the device to wakeup and stay awake is determined based on an accuracy of a clock of the network device, an accuracy of a clock of a different device with which the communication will occur, and the target time. In some embodiments, this padding size includes the total amount of drift that can occur in both clocks during the target time. In this way, a specific window length may be created for a given communication based on how long away the communication will happen, and the accuracy of the clocks on both devices, minimizing the amount of time that a device needs to be in a receive state, thus saving energy, reducing the chances for collisions with other messages, and so on.

In implementations described herein, low-energy devices, such as sensors, are commonly employed. These devices can be powered by solar energy that harness ambient light or by rechargeable batteries that harness ambient light, etc. To optimize their energy usage, these devices assess the energy consumption of the previous cycle and utilize this information to determine the available energy for the next cycle. The timing mechanisms within these individual sensors often employ crystals with oscillations that may exhibit a slight frequency variance, typically measured in parts per million (ppm) or parts per billion (ppb). This minor deviation causes the clocks in separate devices to drift over time, necessitating periodic resynchronization to maintain accurate timing. Synchronization messages are employed to achieve this resynchronization, with the timing of their transmission based at least in part on the precision of the crystal used.

Occasionally, clock drift can exhibit recognizable patterns that can be partially predicted. For instance, a sensor placed in a location with elevated temperature may experience a consistent and known form of clock drift, such as consistently drifting faster or slower. In such cases, the sensor can have an offset value that assists in synchronizing its clock more easily. This offset value may be determined internally within the sensor. The device may be unwired and may have a solar power energy source. The device may have a rechargeable battery. The battery may recharge automatically using ambient light that is harvested using the solar power energy source. The battery may have a year of backup battery charge when the battery is fully charged, nine years of battery life, or a battery life of a different amount.

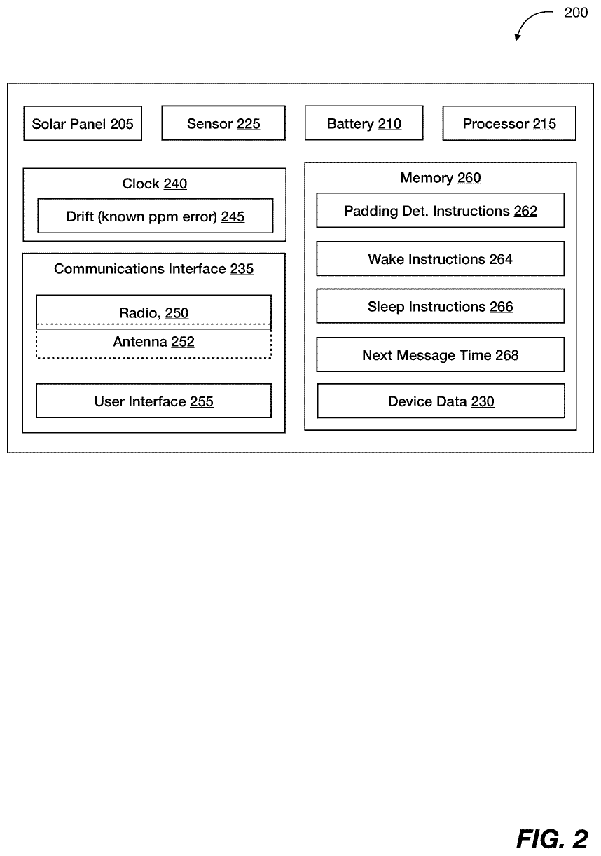

The device may be wired to a controller, which may be a satellite controller, or the like, or may have a wireless connection. The wireless connection may be to a controller, a satellite controller, another device, a web of devices, or the like. The device may report to any sort of device that accepts such a report, such as a sensor, a cell phone, an in-home controller, a satellite controller, a controller, etc. These sensor devices are described in greater detail with reference to FIG. 2.

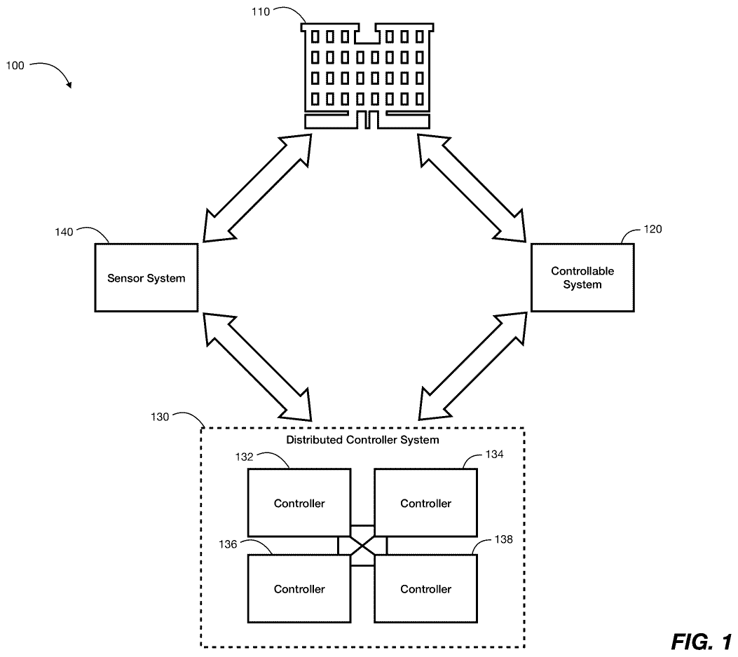

FIG. 1 illustrates an example system 100 for implementation of various embodiments. As shown, the system 100 may include an environment 110, some aspect of which is affected by a controllable system 120. The behavior of the controllable system 120 is, in turn, controlled by a distributed controller system 130. To obtain information useful in making control decisions, the distributed controller system 130 receives data from a sensor system 140 which, in turn, generates its data based on observations from the environment 110.

According to one specific example, system 100 may describe a heating, ventilation, and air conditioning (HVAC) application. As such the environment 110 may be a building whose temperature is to be controlled by the controllable system 120. The controllable system 120 may be the HVAC system itself, which may be controllable to distribute warm or cool air throughout the building 110. Thus, the controllable system 120 may include HVAC equipment such as pumps, boilers, radiators, chillers, fans, vents, etc. The sensor system 140 may include a set of temperature sensors distributed throughout the building 110 to collect and report temperature values.

While various embodiments disclosed herein will be described in the context of sensors within a sensor system, it will be apparent that the techniques described herein may be applied to other applications including, for example, applications for controlling a lighting system, a security system, an automated irrigation or other agricultural system, a power distribution system, a manufacturing or other industrial system, or virtually any other system that may be controlled. Further, the techniques and embodiments may be applied to other applications outside the context of controlled systems. Various modifications to adapt the teachings and embodiments to use in such other applications will be apparent.

As shown, the distributed controller system 130 includes four controllers 132, 134, 136, 138 in communication with one another. The controllers 132, 134, 136, 138 may be located within the environment 110, at another location (such as another environment similar to the environment 110 or in a cloud data center), or some combination thereof. Each controller 132, 134, 136, 138 may be connected to one or more devices, such as individual devices of the controllable system 120 or sensor system 140. Such connection may be direct or indirect (e.g., via one or more intermediate devices such as a network), wired or wireless, or any other type of connection that would enable communication between devices. In some embodiments, each controller 132, 134, 136, 138 may be connected to those devices of the controllable system 120 or sensor system 140 that are physically most proximate to their respective controller 132, 134, 136, 138. For example, where the environment 110 is a building with four floors, the controllers 132, 134, 136, 138 may be installed one on each such floor and then connected to the devices of the controllable system 120 or sensor system 140 physically located on the same floor. Alternatively, devices of the controllable system 120 may be distributed amongst controllers 132, 134, 136, 138 via criteria other than physical proximity, such as demand of the devices on the each controller 132, 134, 136, 138.

The controllers 132, 134, 136, 138 may be identical to each other or may employ different hardware or software. For example, two controllers 132, 134 may be full featured controllers while the other two controllers 136, 138 may be satellite controllers with limited capabilities with respect to the full featured controllers. As another example, one or more of the controllers 132, 134, 136, 138 may be specialized in one or more respects, deployed to work on only a subset of tasks associated with controlling the controllable system 120. As such, the controllers 132, 134, 136, 138 may implement partial or full redundancy of functionality or may divide functionality among themselves (either by pre-installation component design or by post-installation coordination or agreement) to achieve a fully functional distributed controller system 130. While the teachings and embodiments disclosed herein will be described with respect to fully-redundant, fully-featured controllers 132, 134, 136, 138 (unless otherwise noted), modifications for applications of the teachings and embodiments for application to such alternative controller 132, 134, 136, 138 arrangements will be apparent. It will also be apparent that other embodiments may include a greater or fewer number of controllers. In some such embodiments, the system 100 may include only a single controller, rather than multiple controllers cooperating in a distributed manner. Various modifications in such alternative embodiments will be apparent.

Various methods for implementing a distributed controller system 130 may be employed for coordinating the functions of the controllers 132, 134, 136, 138. For example, the controllers 132, 134, 136, 138 may coordinate to elect a single controller 132, 134, 136, 138 to take the function of leader controller, while the remaining controllers 132, 134, 136, 138 become follower controllers. In such an arrangement, each follower controller may perform some limited functionality, such as receiving sensor data from those devices in the sensor system 140 attached to that follower controller, committing such sensor data to a database 226 available to the other controllers 132, 134, 136, 138, calculating sensor data for spaces that have no sensor of their own to give a predicted state values (data fusion), and ensuring proper connections, fault detection, and operation of devices of the controllable system 120 attached to that follower controller.

Meanwhile, the elected leader controller may be responsible for additional functionality such as, for example, training machine learning models, running simulations, and making control decisions for the controllable system 120. In some embodiments, the elected leader controller may rely on the remaining controllers 132, 134, 136, 138 to assist in the performance of these tasks by distributing work among the follower controllers according to various distributed work paradigms that may be employed. For example, the leader controller may break a task to be performed into multiple smaller steps or work packages, transmit the steps or work packages to the follower controllers for performance, receive the sub-results of the steps or work packages back when the work is completed, and use the sub-results to arrive at an ultimate result (e.g., a further trained model, a completed simulation or set of simulations, or a control decision). With regard to control decisions or other actions involving communication with devices of the controllable system 120 or the sensor system 140, the leader controller may determine to which of the controllers 132, 134, 136, 138 the device is connected and send the communication to that controller 132, 134, 136, 138 to then be passed on to the intended device.

It will be understood that FIG. 1 may represent a simplification in some respects. For example, in some embodiments, one or more devices may be both a controllable device (belonging to the controllable system 120) and a sensor device (belonging to the sensor system 140). For example, a controllable pump may have an integrated sensor that reports an observed pressure back to the distributed controller system 130. In some embodiments, there may be multiple controllable systems 120, multiple sensor systems 140, or other systems (not shown) involved in implementing the overall system 100, each of which may or may not be in communication with the distributed controller system 130. Such sensors may be a part of a wired or wireless sensor network, such as discussed below. For example, the distributed controller system 130 may control both an HVAC system and a lighting system, which may be implemented as two independent controllable systems. As another example, the distributed controller system 130 may obtain sensor data from both a set of sensors the distributed controller system 130 manages as well as a set of sensors managed by a third party service (e.g., as may be made available through an API or other network-based service) and, as such, there may be multiple independent sensor systems 140 that inform the operation of the distributed controller system 130. In some embodiments, the distributed controller system 130 may manage controllable systems 120 for multiple environments 110 (e.g., the HVAC systems for two or more separate buildings) or may be in communication with other distributed controller systems 130 associated with implementations of systems similar to system 100 for other environments 110 (e.g., to extend the processing capacity through distribution of work to additional controllers, to execute multi-building control actions, or to gather information from other environments such as predicted power usage). Thus, where the environment 110 is a building, one or more distributed controller systems may implement not only a “smart building” but a “smart city” of multiple buildings coordinating their operations. Various modifications for replicating or otherwise adapting the teachings herein across additional environments, controllable systems, distributed controller systems, or sensor systems will be apparent.

FIG. 2 illustrates an example device that may be used, in whole, or in part, in any of the embodiments disclosed herein. It will be understood that FIG. 2 constitutes, in some respects, an abstraction and that the actual organization of the components of the device 200 may be more complex than illustrated.

A device 200 is disclosed, designed with the capability to actively participate in a network. This network may be a portion of a sensor system 140, or it can be a part of another network system, such as a network that may be used within a controllable system 120. Each device (or device) in the network may have many functionalities, including sending and receiving messages, entering sleep mode, awakening from sleep mode into wake mode, and more. During sleep mode, the device may have the ability to disable or reduce the power consumption of non-essential components such as a radio 250, a processor 215, and parts or the entirety of a communications interface 235. Even though asleep, the device still maintains basic functionality, such as continuing to maintain a clock, and waking up in response to events, such as at a timer set by the device itself. It might also wake up to undefined events of certain types. Upon wakeup, the device may enter active mode allowing it to resume normal operation. In active mode, the device may become capable of transmitting and receiving data, establishing connections with other devices, and performing other tasks. Additionally, there may be additional modes available, such as a low-energy mode. Instructions for specific functions, such as entering wake mode 264, entering sleep mode 266, and other functions may be stored in various storage locations, such as memory 260, firmware, or other relevant locations.

The device 200 may also incorporate a clock 240, which possesses a known ppm error (clock drift) 245. The clock drift 245 may be stored such that the device itself can access it. Clock drift refers to the disparity in the ticking rate between two distinct clocks over time, typically measured in parts per million (ppm). It indicates the relative deviation of a clock from an ideal reference clock during a specific time interval. The measurement in ppm signifies the number of clock cycles gained or lost per million clock cycles. In the context of clock drift, a clock that drifts at a rate of 1 ppm would experience a gain or loss of one clock cycle for every million clock cycles it counts. This measurement provides a precise assessment of clock accuracy and enables comparisons between clocks operating at different frequencies. For example, considering a clock with a frequency of 10 MHz and a drift rate of 1 ppm, in one second, this clock would tick 10 million times. If the clock drifts by 1 ppm, it would deviate by ten ticks. It is important to note that both the sending device and the receiving device are subject to clock drift. The level of of uncertainty is at influenced, at least in part, by the amount of clock drift present in both the sending a receiving devices.

The device itself may further include a solar panel 205, and a battery 210. The solar panel may be based on various types of photovoltaic technologies, such as monocrystalline, polycrystalline, thin-film solar cells or a different sort of solar panel. The battery 210 may store excess solar energy, which may be used to recharge the battery. The processor 215 on board may be able to make certain decisions, such as where to send data, may make calculations, and so on. The processor may be a microprocessor, a microcontroller unit, etc. The processor may comprise high-efficiency signal processing, low power, low cost, or may have other features. Further, the processor may handle radio control, data modulation and demodulation, etc. Memory 260, or programmable input/output peripherals may be present separate from the processor or integrated with the processor. Device data 230 may be stored in memory, as may data sent to and sent from the device. Some actions require knowing the time a next message is expected to be sent. This next message time 268 may also be stored in memory. Some actions also require determining a padding being calculated which may give a time to wake up to ensure that the message is received. The instructions on how to calculate this padding 262 may also be stored in memory, firmware, or elsewhere.

The device can be equipped with one or more sensors 225 that enable it to collect internal and sensor readings. These sensors encompass various types, including air temperature, radiant temperature, atmospheric pressure, sound pressure, occupancy mapping, occupancy detection, occupancy velocity, indoor air quality (such as volatile organic compound and CO2 concentration), light intensity, and more. These sensors can be classified into low power and high power categories, based on the amount of power required for data collection and reading. Device data 230 includes the information sensed by the device's sensors, which is then stored. It should be noted that not all sensed data is stored, as some may be immediately transmitted to another device. The device data encompasses additional details, such as timestamps that record specific events, energy readings like battery and solar panel energy levels, unexpected energy accumulation amounts, and so on. This data can also be stored for specific time periods, and it is typically, though not always, stored in the device's memory 260.

The device may be equipped with a communication interface 235, which can include a radio 250 or a wired communication medium. The radio is responsible for transmitting and receiving data over the airwaves and is comprised of hardware and firmware. Additionally, the radio 250 may be accompanied by an antenna 252, which can be integrated into the radio or a separate component, and which facilitates the transmission and reception of radio waves. This enables the device to establish connections and exchange data with other devices in the network. Moreover, the device may feature a user interface 255 that allows users to interact with it. This interface may consist of buttons, touchscreens, displays, and visual and audio interfaces. For example, users can utilize the interface to commission the device, read sensor data, and perform other related actions. Commissioning may include flashing light at, or sending noise to the device. In some embodiments, the user interface 255 may include a command line interface or graphical user interface that may be presented to a remote terminal via the communication interface 235. Voice User Interfaces, which allow users to interact with systems using spoken commands, Augmented Reality Interfaces (sometimes referred to as Virtual Reality Interfaces, which overlay virtual elements onto a real-world environment, Gesture Based Interfaces which allow users to control computerized objects, devices, systems, etc., based on gestures, may also be used as user interfaces. The communication interface 235 may include a bluetooth transmitter, and specialized control chips. Additionally, the communication interface 235 may also include various alternative or additional hardware or configurations for the communication interface 235 as will be apparent.

The device employs its processor 215 and memory 260 in conjunction with the communication interface 235 to, e.g., receive and pass messages to neighboring devices. A neighboring device refers to a device that is one relay (or hop) away in a network. However, in certain cases, a neighboring device may be two or more hops away. Some of these devices are within wireless low power networks. Low power networks may consist of multiple devices that communicate with each other using a low power protocol. When in low-power networks, or when in other types of networks, devices may spend most of their time in a low-power state, waking up periodically to perform specific tasks. This intermittent operation, and solar panel 205 recharging, along with the efficient timing of wake-up periods, may contribute to extended battery life. For example, a device window timing, such that a device is only on (and using power) for a minimal time, contributes to extended battery life. One way wake-up periods are minimized is by ensuring that the window—when a device is awake—is as small as possible. For example, the window, rather than being a single length, may vary based on one or more of the precision of the clock of the sending device, the precision of the clock on the receiving device and the interval until a next message.

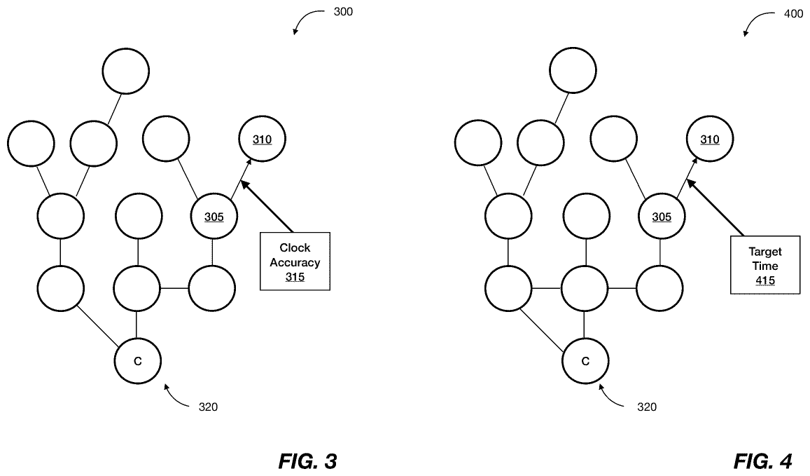

FIGS. 3 and 4 depict two different views 300, 400 of a network device diagram illustrating the potential transmission of a message to prepare for a variable window. This variable window allows a device to activate or deactivate its receive state when anticipating incoming messages. The central device 320 may be a central control processor that is a part of a sensor system 140 that initially sends messages, such as universal synchronization messages, control messages, security messages, data transfer messages, and so on. The central device 320 may be a controller 132, 134, 136, 138 within a distributed controller system 120. To determine the appropriate size of the communication window, in certain scenarios, a sending (upstream device) 305 intending to send a message to a receiving (downstream) device 310 either prior to or simultaneously with the message, communicates the clock accuracy of the upstream device 305 to the downstream device 310. This sending device clock accuracy (or drift) 245, may be stored within the sending device, may be received from a central device 320, or may be received elsewhere. In some instances, a target time 415 for a communication is also sent from an upstream device, e.g., 305 to the downstream device 310. This target time may be a single value that indicates length of time from the current clock, the target time may have a buffer added that is the transmit time from the upstream device, the target time may be the actual time the message may be received, this actual time may have a buffer added that includes transmit time, etc.

The clock accuracy 315 of the sending device passed to the receiving device is used to determine a close-to-optimal window time for the receiving device to be awake, waiting for the message that will appear at the target time 415. This clock accuracy may be sent to the receiving device 310 from the sending device 305 when the sending device 305 first contacts the receiving device 310, at each message transmission, or at a different time.

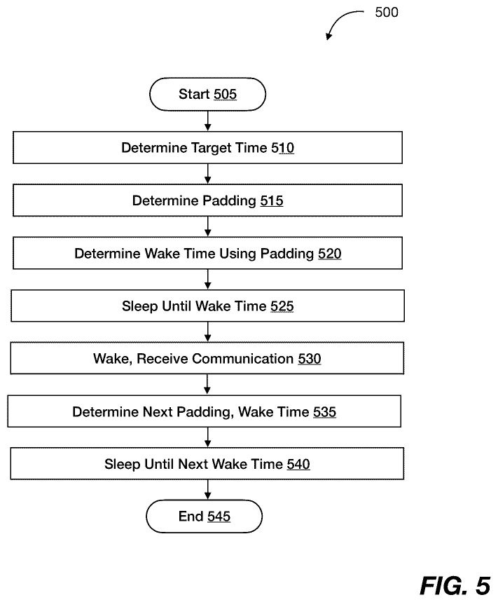

FIG. 5 illustrates an example method 500 for determining window length for a message in a network. The method 500 may be performed by a device in a network, by a processor that has communications with the devices in the network, etc.

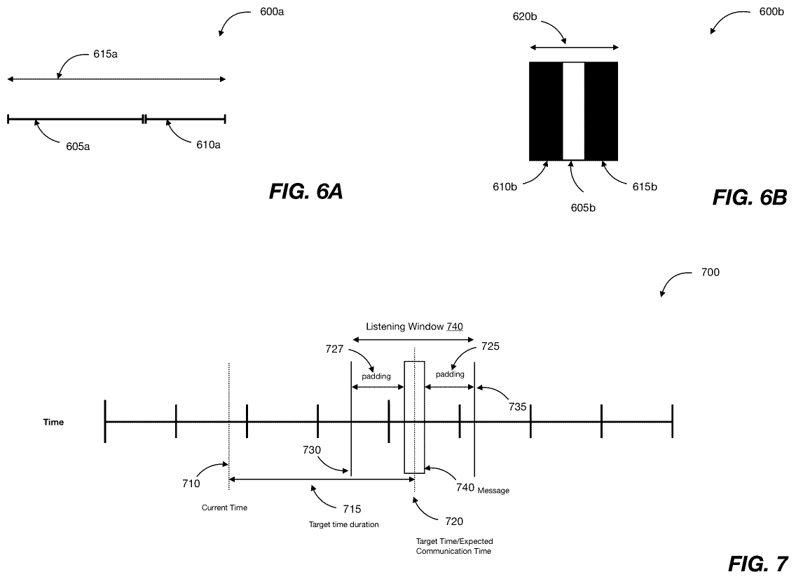

The method 500 may begin in step 505 in response to, for example, a need for communication to a device—the receiving device. This communication may involve exchanging data with other devices in a network; configuration or control commands to adjust behavior or to perform specific actions; status updates, synchronization commands to maintain accurate timing or to maintain accurate coordination with other devices in the network and elsewhere, firmware updates for bug fixes, functionality updates, etc., software updates for bug fixes, functionality updates, etc. ; network management such as network discovery, device pairing, security authentication, network status monitoring, and so forth; or for another purpose. For example, a receiving device may receive a synchronization message with a global time to use to reset the receiving device's internal clock. The method proceeds to step 510, where a target time may be determined. This target time may be sent to the receiving device via a communications from another device, as shown with reference to FIG. 4 at 415. This target time may be sent as a single message, or as part of a more complex message that includes other information. The target time may be the time at which the packet with the message was sent by the sending device, a universal time that was originally sent by a processor, an offset time from the current time, an offset time plus a transmission time, the target time plus a packet make and send offset, or a value that will be interpreted a different way. At step 515, a padding is determined. This padding may be the amount of time that the receiver should be awake to ensure that a message is received from a sender. A more detailed description of determining padding can be found with reference to FIGS. 6A, 6B, and 7, and the surrounding text.

At 520, the wake-up time is determined using the padding. Though this is covered in great detail with reference to FIG. 7, basically, the wakeup time is the target time minus the padding, minus half the message length. Once the wake-up time has been determined, at 525, the device may go to sleep until the wakeup time. At 530, the device may wake up at the wakeup time 730, (with reference to FIG. 7), which is the start of a listening window 740, and wait for the communication. The communication is expected to arrive during the listening window 740. The communication may contain the expected time of a next communication, or the expected time of a next communication may be known through other means. While still awake, the device may determine the next padding for the next message, and using that padding, may determine its next wake-up time 535. At 540, the device may then sleep until that next wake time. At 545, the method ends.

At some point, as shown with reference to FIG. 3, the receiving device has received the clock accuracy of the sending device. With reference to FIG. 2, the receiving device knows the accuracy 245 of its own clock 240. The receiving device also knows the target time of a next message, as shown with reference to FIG. 4 at 415. Knowing the accuracy of both clocks and how far out the next message (e.g., the target time) is to be received, the amount of timing inaccuracy due to clock drift can be calculated.

FIG. 6A is an example illustration 600a of one way to determine a padding time based on clock drift, which finds application in various contexts, such as determining window size for device messages, and determining a universal synchronization interval. An example where window size usage is relevant is in determining when a device will be in a wake state to receive a message, also know as the listening window. To calculate the padding 615a, one approach involves determining total clock drift resulting from the inaccuracies of both the sending clock and the receiving clock for the the amount of clock drift that will occur due to the inaccuracy of the sending clock 605a for the duration of time up to the target time 615a plus the amount of clock drift that will occur due to the inaccuracy of the receiving clock 615a for the duration of time represented by the target time 615a. For example, an equation such as the following may be used: (Sending Clock Drift rate*target time duration) 605a+(Receiving Clock Drift rate*target time duration) 610a. The resulting value represents the length of the padding 615a, accounting for clock drift. It is important to consider the “worst case scenario” for clock drift, which occurs when the two clocks drift in opposite directions—one running fast and the other running slow. Consequently, the padding calculation described above is applied on both sides of the target time, resulting in padding segments 610b and 615b (as shown with reference to FIG. 6B), with the message length positioned in the middle (605b). Therefore, the total padding for the window is twice the value obtained from the clock drift calculation. For a more comprehensive understanding of this concept, please refer to the discussion with reference to FIG. 7.

FIG. 7 discloses a timeline 700 that illustrates the process of determining a listening window for a given message. Upon receiving a target time 720 at a current time 710, the duration between the current time 710 and the target time 720 is defined as the target time duration 715. This duration serves as the reference point for scheduling the window opening time. To establish the start and finish time of the listening window 620b, it is assumed that the midpoint of the listening window 620b aligns with the target time 720. The listening window start time is determined by subtracting the padding time 727 (same as 610b) and half the message time 740 (same as 605b) from the target time 720, while the listening window finishing time 735 is obtained by adding the padding 725 (same as 615b) and half of the message time 740 to the target time 720. This assembly of time parameters allows for the delineation of the listening window and ensures appropriate timing for message reception within the desired timeframe.

Once the padding time has been determined, it becomes possible to optimize other timing parameters within the network. For instance, the frequency of system synchronization can be established to maintain network synchronization within reasonable bounds. Synchronization involves aligning the timing of multiple devices to a common reference. Within a network context, this entails exchanging messages among devices and the controlling processor to ensure a shared understanding of the current time. Such synchronization enables coordinated data transmission, reception, and processing among devices. By aligning their timing, devices can ensure reliable message delivery and uphold network integrity. However, excessively frequent network synchronization can lead to drawbacks such as increased power consumption, higher overhead, reduced efficiency, and elevated network latency. Conversely, insufficient synchronization frequency can result in data transmission errors, packet loss, reduced data throughput, and decreased overall reliability. Therefore, maintaining an accurate synchronization time is crucial for establishing a stable and energy-efficient network.

Low-power wireless networks, like Bluetooth Low Energy networks, lack system-wide synchronization and instead rely on interval-based synchronization for message exchange between devices. This involves coordinating intervals for activities such as advertising, scanning, and connection establishment. However, internal synchronization mechanisms of this nature may be prone to energy-intensive errors due to factors such as unaccounted clock drift. For instance, source devices may send messages that fall outside the time window of the destination device, necessitating message retransmissions. Accordingly, methods for synchronizing an entire low-energy network to a system time are described to address these challenges and enhance network performance.

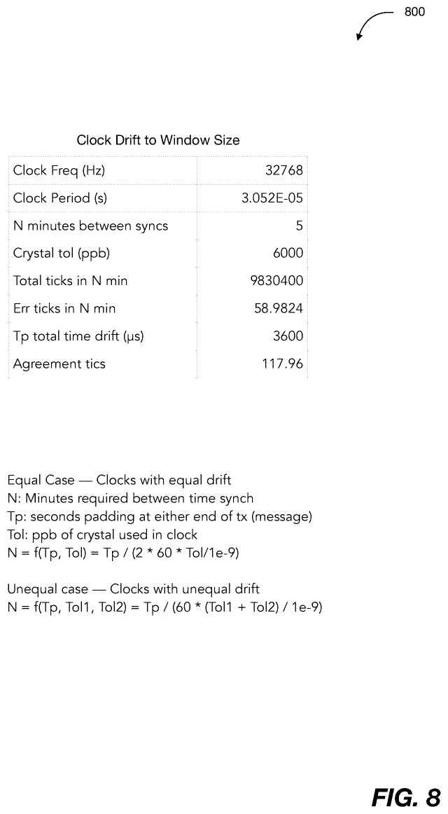

FIG. 8 at 800 shows some ways to determine an optimal synchronization timing using the padding time that we have previously determined and the accuracy of a system clock. The synchronization time may equal the padding time Tp/(2*60*the ppb (parts per billion) of the crystal used in the system clock)/1e−9, or a different method may be used.

Devices can achieve synchronization among themselves, particularly when incorporating a new device into an existing network. To facilitate internal synchronization, each device may allocate specific time slots dedicated to these synchronizations at predetermined intervals. These known internal synchronization time slots serve the purpose of synchronizing devices within the network and may occur more frequently than system-wide synchronizations. An example of this can be observed in FIG. 8, where the synchronization time interval for the given parameters is set at 5 minutes. During these intervals, numerous messages can be exchanged among devices utilizing the internal synchronization time slots.

Methods and systems that outline the automatic enrollment of devices into a synchronized mesh network, employing such synchronization slots for individual devices, are further described in Ser. No. 17/986,603 , filed on Nov. 14, 2022, which is incorporated herein by reference for all it contains. As part of the enrollment process for a new, lost, or previously disconnected device, the device receives a synchronization message containing crucial information for smooth integration into the network. This information may include details about the existing network structure, available enrollment channels, and the reference or universal network synchronization time. The reference network synchronization time, which may be stored in a network synchronization field within the synchronization message, can be utilized by the device to determine predefined synchronization times. The network synchronization field serves as an example of a field that can be updated with a universal synchronization time, as discussed in the context of FIG. 8.

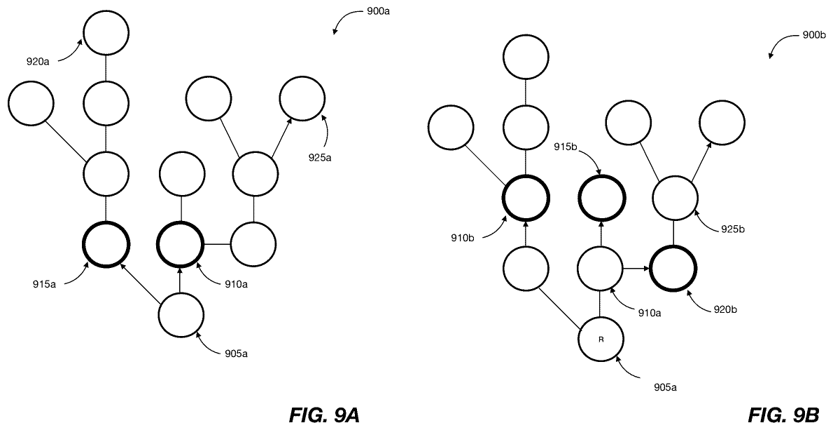

FIGS. 9A and 9B show a simple wireless network 900a, 900b with possible connections shown. Each device is a number of hops from a central device. Device 905a is the connection to a central device 905a, such as described with reference to 320 in FIG. 3, and so on. Device 910a is one hop from the central device 905a; device 920a and 925a are both four hops from the central device 905a. At a determined time (such as at a 5 minute mark as described with reference to FIG. 8), a synchronization message that contains a new universal synchronization time is sent from the central device 905a to the devices that are a single hop away; e.g., 910a, 915a. The next time a sync message is sent from the first hop devices to second hop devices (e.g., 915a to 910b; 910a to 915b, and 910b to 920b) the universal synchronization time will be included in the sync message. Sync messages may be sent for many reasons other than for universal synchronization, for example, when devices are added or deleted from the network, etc. When a sync message is sent from the second hop devices to the third hop devices, the sync message will have the new universal synchronization time, and so on. This allows the new universal synchronization time to be populated through the entire network with very little extra energy expenditure.

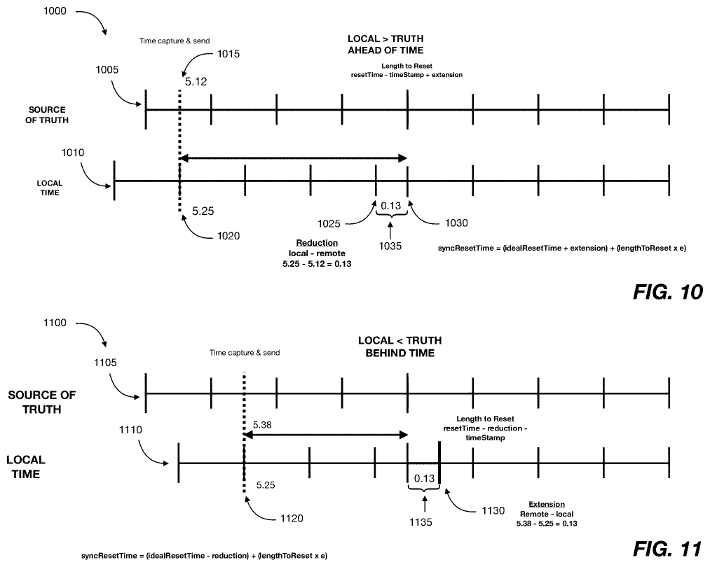

FIG. 10 shows an embodiment of a timeline 1000 describing a way to sync the local time in a network device to match a reference time when a device local time is ahead of a reference time. The timeline 1005 is the reference timeline of a device (such as a central processor) with the time considered the “truth” for the network. The timeline 1010 is the local time for a device. A sync message is received by the local device at 1020, which is 5.25 in the local time. The time given in the sync message—the reference time, is 5.12 1015. In this case, the difference between the local time and the reference time is 0.013, the amount of time that the device should adjust its internal clock forward to align with the the reference time—the extension time. In some embodiments, the local time is adjusted immediately forward. In some embodiments, the device local time will be adjusted at a predefined reset time 1025. This predefined reset time may be at a round clock time, an amount of time from the current time, etc. At that predefined reset time the extension 1035 (in the current instance 0.13) is added to the local time. This aligns both timelines. Other methods and systems may be used as well. For example in some embodiments, the Sync reset time is (an ideal reset time+the extension)+(the length to reset*e).

FIG. 11 shows an embodiment of a timeline 1100 describing a way to sync the local time in a network device to match a reference time when a device local time is behind a reference time. The timeline 1105 is the reference timeline of a device (such as a central processor) with the time considered the “truth” for the network. The timeline 1110 is the local time for a device. A sync message is received by the local device at 1120, which is 5.25 in the local time. The time given in the sync message—the reference time, is 5.38 1015. The difference between the local time and the reference time is −0.013, the amount of time that the device should adjust its internal clock back to align with the the reference time—the reduction time, as shown at 1135. In some embodiments, the local time is adjusted immediately backwards. In some embodiments, the device local time will be adjusted backwards by the reduction time at a predefined reset time 1130 which sets the clock back, aligning both timelines. Other methods and systems may be used as well. For example in some embodiments, the Sync reset time is (an ideal reset time−the reduction)+(the length to reset*e).

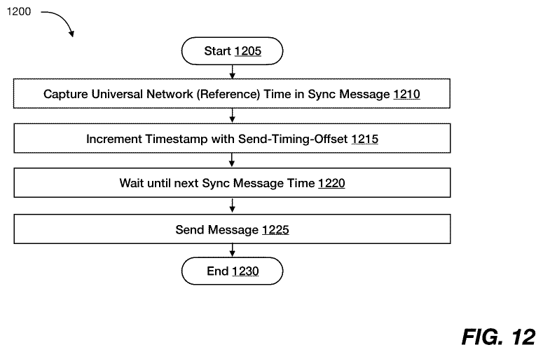

FIG. 12 illustrates an example method 1200 for a device to update its universal synchronization time. The method 1200 may be performed by a device such as device 500, and may correspond, for example, to resetting a universal synchronization time, such as discussed with reference to FIGS. 10 and 11.

The method 1200 may begin at step 1205, in response to, for example, receiving a universal synchronization message with a time (a reference time) in a listening window 740. The method proceeds to step 1210 where the reference time (the universal time) is captured. This time may be captured, for example, during a listening window in a sync message, in, e.g., a network time field. As described with reference to FIGS. 10 and 11, at step 1215, the local time of the device is either incremented or decremented by the offset between the local time and the reference time. At step 1220, in some embodiments, a sync message with the reference time previously sent to this device may be created, in some embodiments, the original sync message captured at step 1210 may be saved. The message is not sent immediately; rather, the device waits until a time that has previously been determined to talk to children of the device and sync the children. With reference to FIG. 9A, the device 910a has two children 915b and 920b. In some embodiments, device 910a will have set times that it knows to send sync messages to device 915b, and 920b. When device 925b receives a sync message from device 920b, it will wait until its time to sync to its child 930b before sending a sync message to 930b. This way, the synchronization messages propagate through the system at set times, and so do not create congestion, e.g., as synchronization messages are staggered. Furthermore, the network stays synchronized even with clock drift. Collisions are also unlikely to happen, as messages are sent in an organized fashion. At step 1225, the next synchronization message is sent to the children of the current device—with each child receiving its own synchronization message at its set time. At step 1230, the method ends.

It should be apparent from the foregoing description that various example embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a mobile device, a tablet, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain example aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the scope of the claims.

We claim:

1. A network device comprising:
A memory;
A communications interface; and
A processor in communication with the memory configured to:
determine a target time at which a communication via the communications interface is anticipated to occur;
determine a padding based on an accuracy of a clock of the network device, an accuracy of a clock of a different device with which the communication will occur, and the target time;
determine a wake time based on the padding;
sleep until the wake time; and
after waking at the wake time, perform the communication.

2. The network device of claim 1, wherein in determining the wake time, the processor is configured to subtract the padding from the target time.

3. The network device of claim 1, wherein the processor is further configured to:
determine a next sleep time based on the padding; and
after waking at the wake time, place the network device in a sleep state at the next sleep time.

4. The network device of claim 3 wherein in determining the next sleep time, the processor is configured to:
subtract the padding from the target time.

5. The network device of claim 1, wherein in determining the padding, the processor is configured to:
identify a time interval between a current time and the target time; and
estimate a worst case clock drift using accuracy of the clock of the network device and
an accuracy of the clock of the different device over the time interval.

6. The network device of claim 5, wherein in estimating the worst case clock drift, the processor is configured to:
determine accuracy of the clock of the network device based on a property of a crystal oscillator of the clock of the network device, and
determine accuracy of the clock of the different device based on a property of a crystal oscillator of the clock of the different device.

7. The network device of claim 6, wherein estimating the worst case clock drift further comprises the processor being configured to estimate an amount of clock drift between the current time and the target time using the accuracy of the clock of the network device giving a device drift time.

8. The network device of claim 7, wherein estimating the worst case clock drift further comprises the processor being configured to estimate an amount of clock drift between the current time and the target time using the accuracy of the clock of the different device giving a different drift time.

9. The network device of claim 8, wherein a padding value is the device drift time plus the different drift time and wherein the padding is twice the padding value.

10. The network device of claim 1, wherein the communication is a synchronization communication.

11. A method comprising:
determining a target time at which a communication via a communications interface is anticipated to occur;
determining a padding based on an accuracy of a clock of a device in a network, an accuracy of a clock of a different device with which the communication will occur, and the target time;
determining a wake time based on the padding;
sleeping until the wake time; and
after waking at the wake time, performing the communication.

12. The method of claim 11, wherein the padding is used to determine a synchronization interval.

13. The method of claim 12, wherein at a synchronization interval a universal synchronization time is sent from a central device to at least one device in direct communication with the central device.

14. The method of claim 13, wherein the universal synchronization time is sent in a sync message.

15. The method of claim 13, wherein the universal synchronization time is sent to a next device during a regularly scheduled message time.

16. The method of claim 11, further comprising:
determining a next sleep time based on the padding; and
after waking at the wake time, placing the device in a sleep state at the next sleep time.

17. A non-transitory machine-readable medium encoded with instructions for execution by a processor for causing a device to trigger an action on a second device, the non-transitory machine-readable medium comprising:
instructions for determining a target time at which a communication via a communications interface is anticipated to occur;
instructions for determining a padding based on an accuracy of a clock of a device in a network, an accuracy of a clock of a different device with which the communication will occur, and the target time;
instructions for determining a wake time based on the padding;
instructions for sleeping until the wake time; and
instructions for after waking at the wake time, performing the communication.

18. The non-transitory machine-readable medium of claim 17, further comprising:
instructions for determining a next sleep time based on the padding; and
instructions for placing the device in a sleep state at the next sleep time after waking at the wake time.

19. The non-transitory machine-readable medium of claim 17, further comprising instructions for using the padding to determine a synchronization interval.

20. The non-transitory machine-readable medium of claim 19, further comprising instructions for sending a synchronization interval a universal synchronization time from a central device to at least one device in direct communication with the central device.
